(19) United States
(12) Patent Application Publication
(10) Pub. No.: US 2009/0302566 A1
(43) Pub. Date: Dec. 10, 2009

(54) Foldable Scooter

(76) Inventor: Choi Wan Chan, Hong Kong (HK)

Correspondence Address: OR, NG & CHAN, 15TH FLOOR, THE BANK OF EAST ASIA BUILDING, 10 DES VOEUX ROAD CENTRAL, HONG KONG, HK

(21) Appl. No.: 12/134,229

(22) Filed: Jun. 6, 2008

(51) Int. Cl. B62M 1/00

(52) U.S. Cl. 280/87.041

(57) ABSTRACT

The scooter of the present invention includes a footboard, a steering column and a connecting member in between. An engaging member is provided for engaging the rear portion of the connecting member with the front portion of the footboard at the respective open and folded conditions. A rotational driving member operating between a locked position and a released position is provided for driving said engaging member between the open and folded conditions. A first biasing device is provided for disengaging the engaging member from the connecting member and the footboard at the released position of the driving member. The driving member is acted against the biasing device to engage the engaging member with the connecting member and the footboard at the locked position. The engaging member can be easily and conveniently engaged and disengaged by turning the driving member between the locked and released positions.

### FIELD OF THE INVENTION

The present invention relates to a foldable scooter.

### BACKGROUND OF THE INVENTION

There are numerous foldable scooter, for example, the U.S. Pat. No. 6,270,095B1 and U.S. Pat. No. 6,234,501B1. The main disadvantage of these two cited arts is that the folding mechanism is located on the footboard and is exposed to the outside, which can be easily activated by the user when riding the scooter by accident. The location of the mounting seats on the footboard also cause inconvenience to the user when riding the scooter. The mounting seats being exposed will easily injure the user when accident occurs. A better scooter is to be provided to eliminate any parts that stick out from the surface of the scooter.

The mounting seats in U.S. Pat. No. 7,156,405B1 are covered by a connector plate, but the slots on the plate is a dangerous feature as the user may inadvertently place the finger in the slot when folding the scooter, and be injured by the flanges moving in the slots.

There is another foldable scooter existing in the market as shown in FIGS. 1a and 1b. The disadvantage of this foldable scooter is that such folding assembly contains many open slots 910, 920, 930 for the corresponding parts to slide therein or to provide space for the folding, which cause potential hazards to the user when folding the scooter. The user may accidentally place the finger in one of the slots 910, 920, 930 and be injured when the scooter is being folded.

The lever 940 being located on the upper surface of the footboard also cause inconvenience to the user when riding the scooter. When riding the scooter, the user may accidentally kick the lever and cause the scooter to collapse to the folded condition. The footboard should be kept free from any mechanical parts.

Pulling the handle requires force from the user to release the folding mechanism. An improved scooter is to be provided to adopt a more easy and convenient mechanism to release the folding mechanism.

### SUMMARY OF THE INVENTION

It is an objective of the present invention to provide an improved foldable scooter which is more safe and convenient to the user.

The scooter of the present invention includes a footboard, a steering column and a connecting member in between. The connecting member includes a front portion rotatably connected to the steering column, a rear portion pivotally connected to the front portion of the footboard. An engaging member is provided for engaging the rear portion of the connecting member with the front portion of the footboard at the respective open and folded conditions. A rotational driving member operating between a locked position and a released position is provided for driving said engaging member between the open and folded conditions. A first biasing device is provided for disengaging the engaging member from the connecting member and the footboard at the released position of the driving member. The driving member is acted against the biasing device to engage the engaging member with the connecting member and the footboard at the locked position.

An advantage of the present invention is that the engaging member can be easily and conveniently engaged and disengaged by turning the driving member between the locked and released positions.

Another advantage is that the driving member is provided on the side of the connecting member. The driving member is round in shape to prevent potential danger to the user. As a torque motion is required to activate the driving member, the driving member will not be inadvertently activated during the riding of the scooter.

In the present invention, the main parts involved in the folding mechanism including the pivot pin, the engaging member, the biasing devices, the stopper and the notch are all substantially shielded from the user when riding the scooter.

The present invention eliminates most of the slots and open spaces from exposing to the outside, which may cause injury to the user during the opening and folding of the scooter.

### BRIEF DESCRIPTION OF THE DRAWINGS

The above and other aspects, features, and advantages of the present invention will become more apparent upon consideration of the following detailed description of preferred embodiments, taken in conjunction with the accompanying figures, wherein:

FIG. 1a is a perspective view of a foldable scooter currently available in the market.

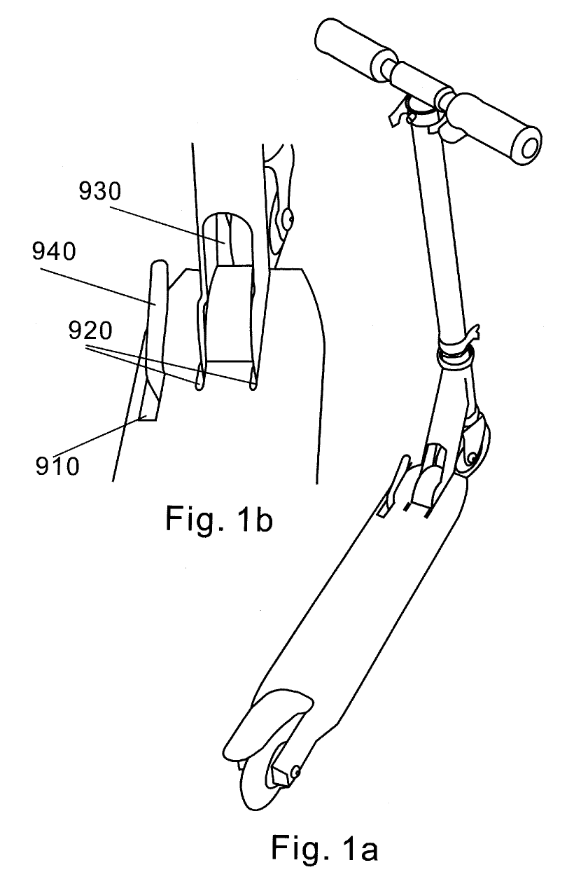

FIG. 1b is a partial perspective view of the foldable scooter in FIG. 1a.

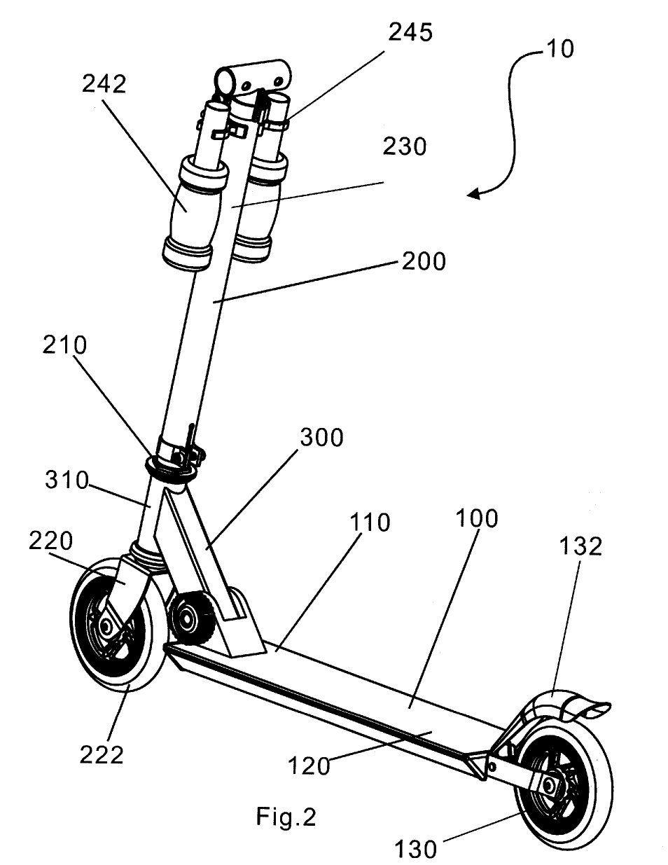

FIG. 2 is a perspective view of an embodiment of this invention.

FIG. 3 is a side view of the foldable scooter in FIG. 2 in the open condition.

FIG. 4 is a side view of the foldable scooter in FIG. 2 in the folded condition.

FIG. 5 is an explosive view of the foldable scooter in FIG. 2.

FIG. 6 is a partial explosive view of the foldable scooter in FIG. 2.

FIG. 7a is a magnified perspective front view of the engaging member in FIG. 5.

FIG. 7b is the side view of the engaging member in FIG. 7a.

FIG. 7c is the magnified perspective back view of the engaging member in FIG. 5.

FIG. 8a is a magnified perspective front view of the driving member in FIG. 5.

FIG. 8b is a magnified perspective back view of the driving member in FIG. 5.

FIGS. 9a-d illustrate the corresponding positions of the locking member, the stopper, and the notches in FIG. 5 between the open and folded conditions.

### DESCRIPTION OF A PREFERRED EMBODIMENT OF THE INVENTION

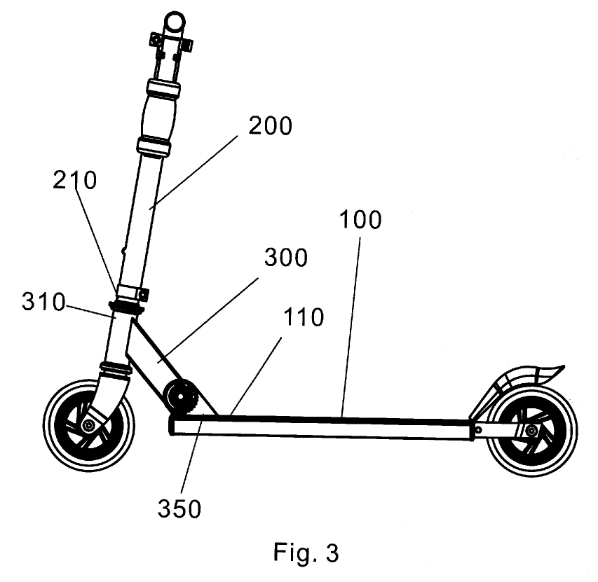

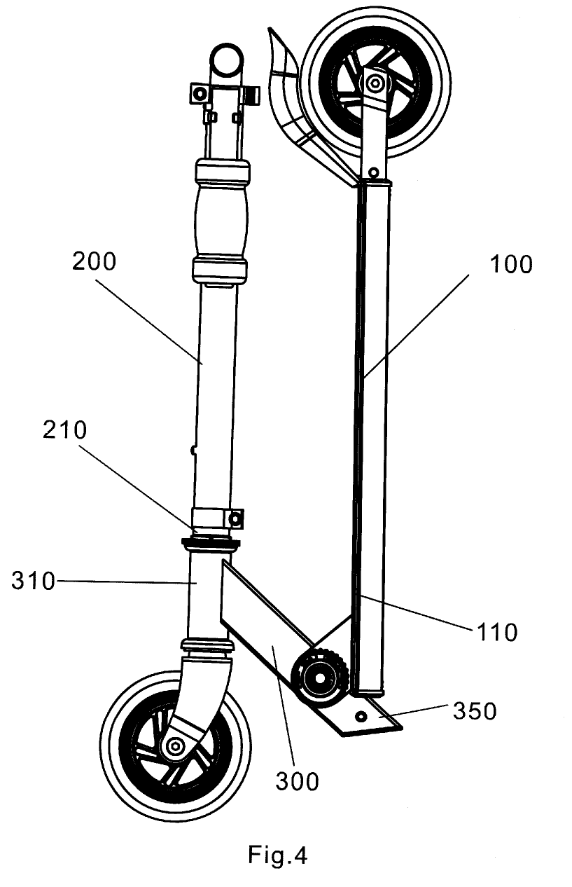

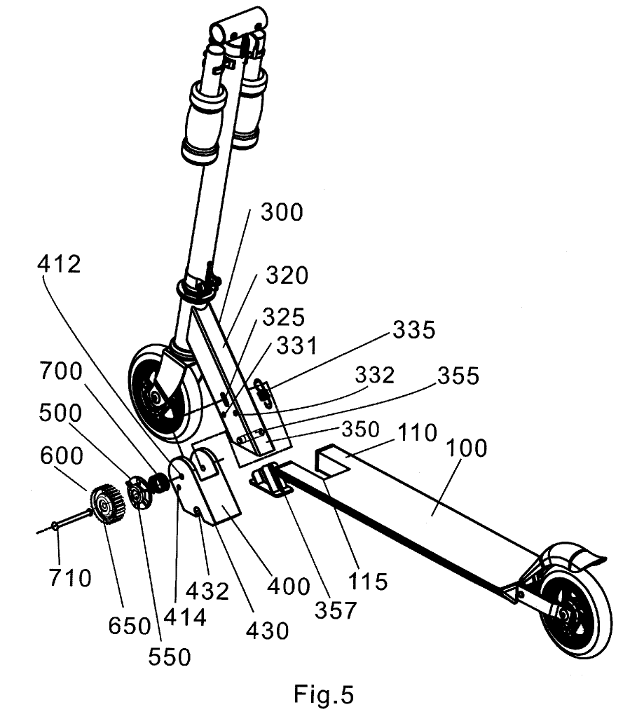

As shown in FIGS. 2, 3 and 4, a preferred embodiment of the present invention is a scooter 10 including a footboard 100, a steering column 200 and a connecting member 300 connecting the footboard 100 to the steering column 200.

The connecting member 300 has a front portion 310 rotatably connected to the steering column 200, a rear portion 350 pivotally connected to a front portion 110 of the footboard 100 and an elongated housing 320 in between the front portion 310 and the rear portion 350. The front portion 310, for example, is a cylindrical hollow column surrounding a lower portion 210 of the steering column 200 such that the steering column 200 can be turned freely inside the front portion 310.

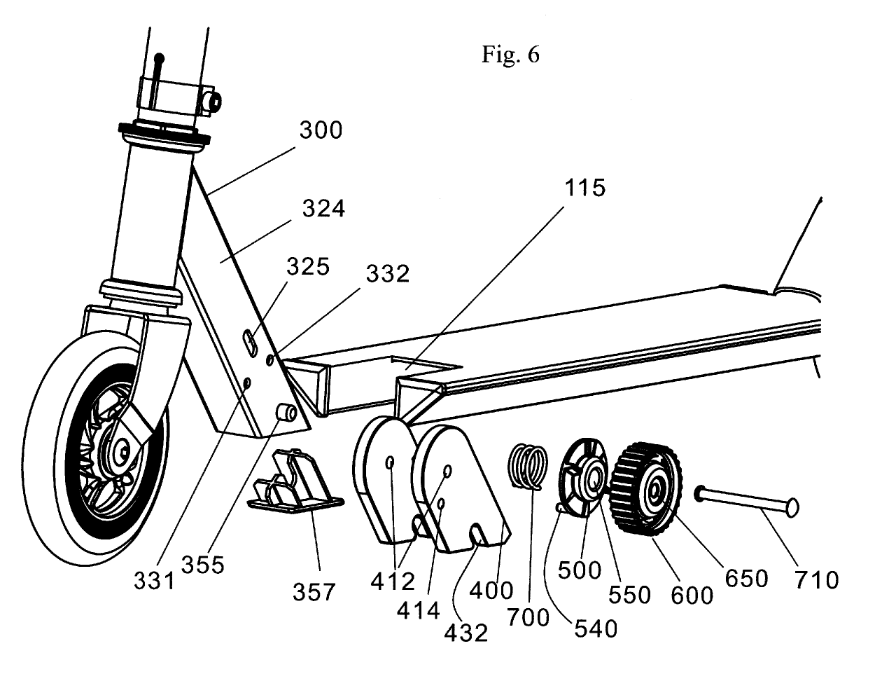

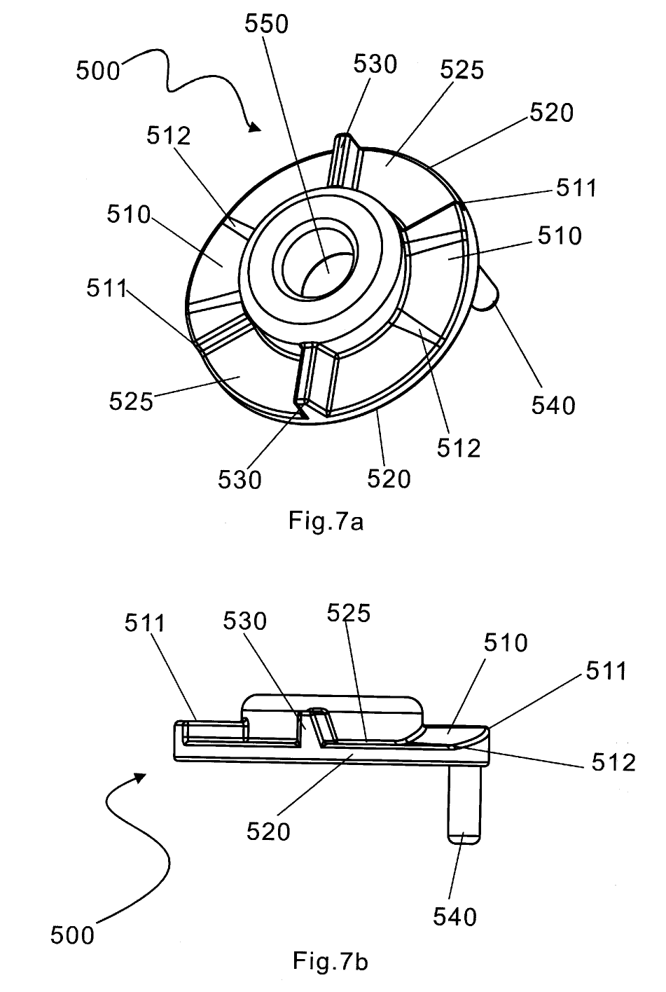

As shown in FIGS. 5 and 6, the elongated housing 320 with two walls 324 on the side. The rear portion 350 includes a stopper 355 extending through the rear portion 350 and extending out from the side walls 324. A cut-out portion 115 is formed at the front portion 110 of the footboard 100 for attaching an extended open housing 400. A pair of notches 432 is formed at a base 430 of the extended open housing 400 for engaging with the stopper 355. The extended open housing 400 is aligned with and receives the connecting member 300 in the open condition.

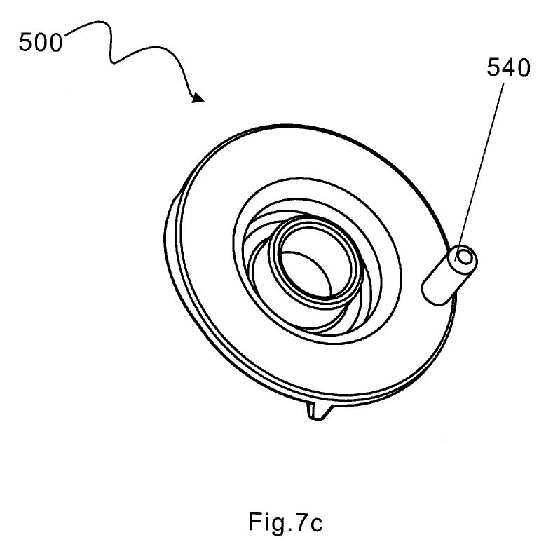

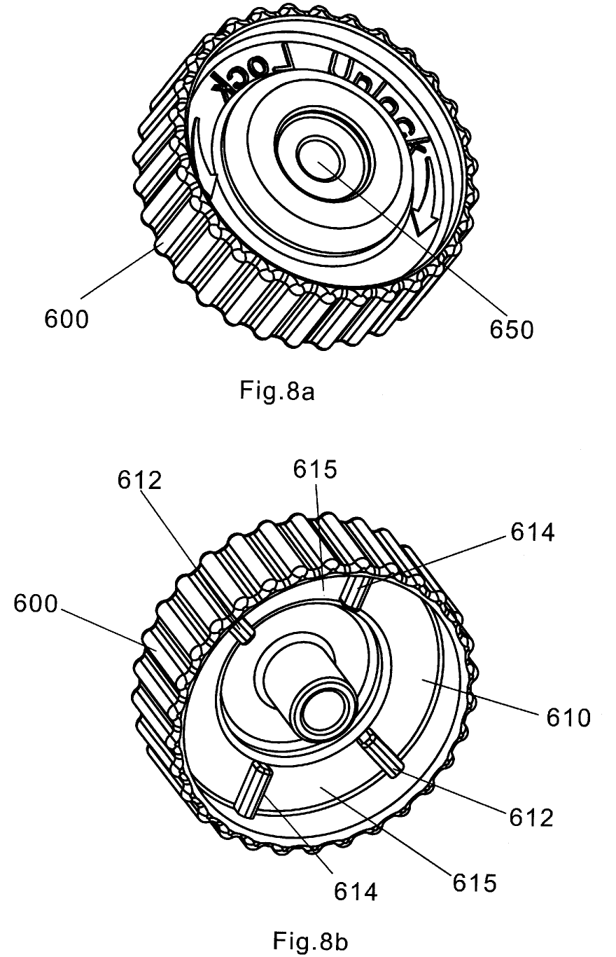

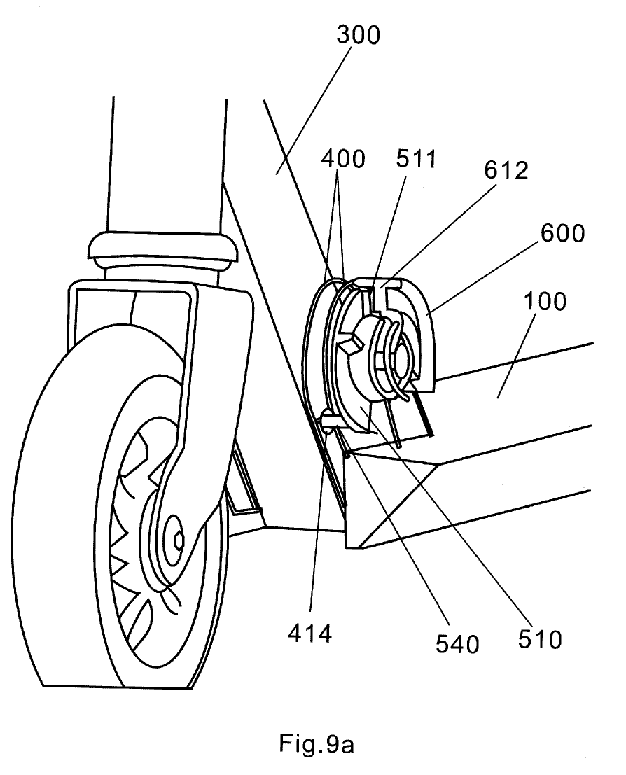

As shown in FIGS. 7a, 7b and 7c, an engaging member 500 includes a circular uniformed plane 520 of the same thickness. In the present embodiment, two inclined planes 510 are formed on the peripheral sector 525 of the uniformed plane 520. Each inclined plane 510 includes a first end 511 and a second end 512. The perpendicular distance from the first end 511 to the uniformed plane 520 is greater than the perpendicular distance from the second end 512 to the uniformed plane 520. In the present embodiment, two stoppers 530 are extended from the peripheral sector.

As shown in FIGS. 5 and 6, an engaging pin 540 is disposed on the other side of the engaging member 500 for engaging with a first engaging hole 331 and a second engaging hole 332 on the side wall 324 of the connecting member 300 correspondingly in the open and folded conditions. A third engaging hole 414 is also provided on the extended open housing 400 for engaging with the engaging pin 540. The engaging pin 540 locks the connecting member 300 against the extended open housing 400 of the footboard 100 in the open and folded conditions.

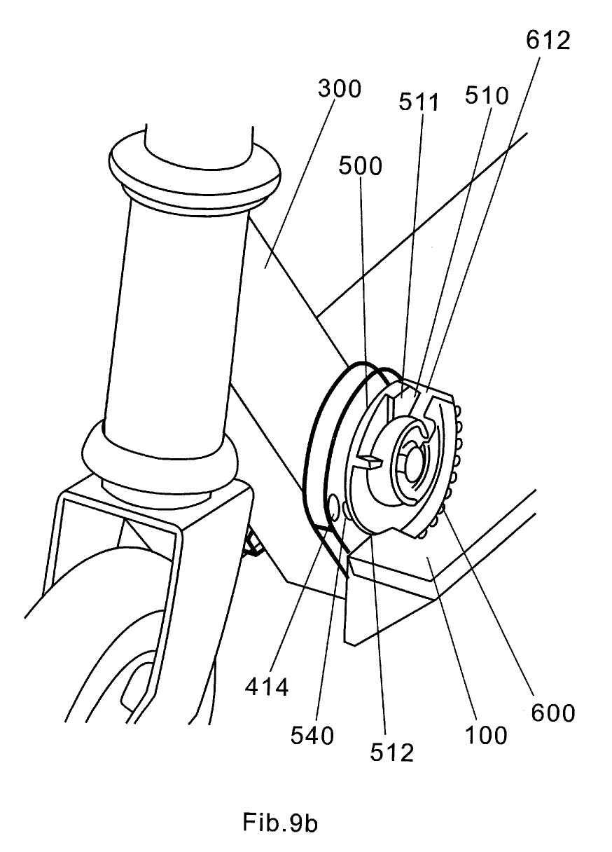

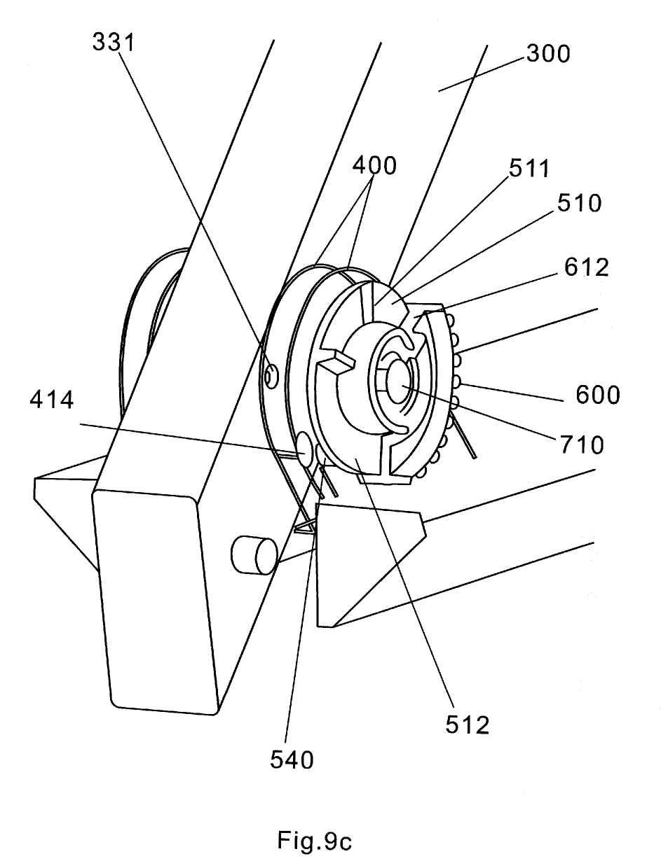

A first biasing device 700, for example, a spring is disposed between the engaging member 500 and the extended open housing 400. The engaging member 500, except the engaging pin 540, is contained in a cavity 610 of a driving member 600 as shown in FIGS. 8a and 8b. A pivot pin 710 connects the driving member 600, the engaging member 500, the extended open housing 400 with the connecting member 300 through a hole 650 on the driving member 600, a hole 550 on the engaging member 500, a pivot hole 412 on the extended open housing 400, and a pivot slot 325 on the connecting member 300.

In the open condition, a second biasing device 335 is attached between the pivot pin 710 and the stopper 355 for biasing the stopper 355 against the notch 432. A lower cover 357 is attached to the rear portion 350 to shield the second biasing device 335, and the pivot pin 710.

As shown in FIGS. 8a and 8b, two extended first portions 612 are disposed in the cavity 610 of the driving member 600. By turning the driving member 600, the extended first portion 612 is slid against the corresponding inclined plane 510 of the engaging member 500 between the first end 511 and the second end 512. The first biasing device 700 biases the engaging member 500 against the driving member 600. When the extended first portion 612 is driven to the first end 511, the engaging pin 540 is engaged with the first engaging hole 331 of the connecting member 300. The engaging member 500 is in the locked position. When the extended first portion 612 is driven to the second end 512 by turning the driving member 600, the first biasing device 700 will release and force the engaging pin 540 to move away from the first engaging hole 331. The driving member 600 is in the released position where the connecting member 300 is the footboard 100 are free to rotate between the open and folded conditions.

Two extended second portions 614 are disposed apart from the extended first portions 612. The stoppers 530 of the engaging member act against the extended second portions 614 to confine the rotation of the driving member 600. An indented third portion 615 is formed between each first and second portion 612, 614 for receiving the first end 511 of the inclined plane 510 in the released position.

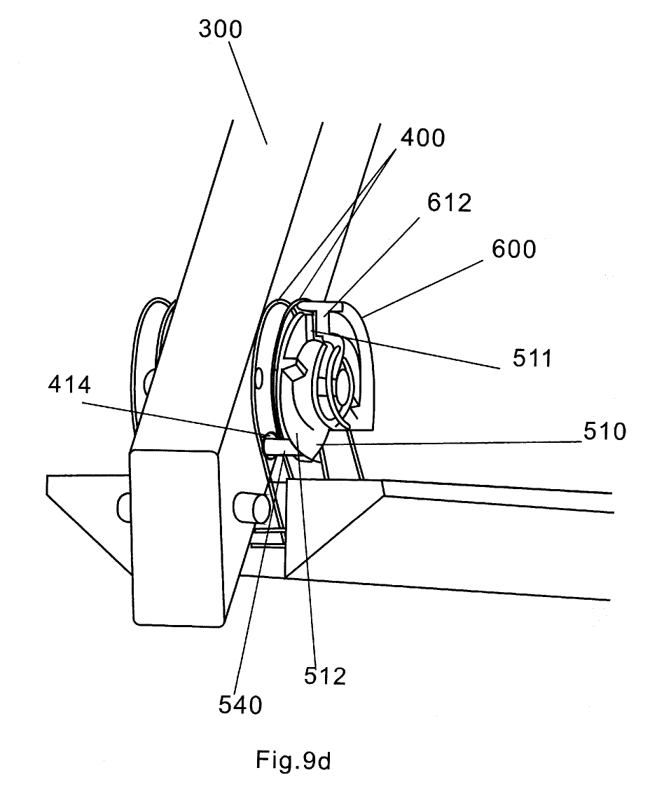

As shown in FIG. 9a, the scooter 10 is in the open condition. The extended first portion 612 is positioned at the first end 511 of the inclined plane 510. The driving member 600 is in the locked position. The engaging pin 540 is engaged with the third engaging hole 414 of the extended open housing 400 and the first engaging hole 331 of the connecting member 300. The stopper 355 of the connecting member 300 is engaged with the notches 432 of the extended open housing 400. The connecting member 300 and the footboard 100 are locked in the open condition.

As shown in FIG. 9b, the driving member 600 is turned from the locked position. The extended first portion 612 moves from the first end 511 towards the second end 512 of the inclined plane 510. The first biasing device 700 moves the engaging member 500 outward and moves the engaging pin 540 away from the first engaging hole 331 of the connecting member. When the extended first portion 612 is positioned at the second end 512 of the inclined plane 510, the engaging pin 510 is totally disengaged from the first engaging hole 331. The driving member 600 is in the released position. The connecting member 300 is disengaged from the footboard 100 and is free to be folded toward the footboard 100 to the folded condition.

As shown in FIG. 9c, the connecting member 300 is slid downward to remove the stopper 355 from the notches 432. The pivot pin 710 is slidable along the pivot slot 325 when the stopper 355 is disengaged from the notches 432. The connecting member 300 is then folded toward the footboard 100. The engaging pin 540 is not yet engaged with the third engaging hole 414 of the extended open housing 400 and the second engaging hole 332 of the connecting member 300 yet.

As shown in FIG. 9d, the driving member 600 is turned into the locked position. The extended first portion 612 moves from the second end 512 back to the first end 511 of the inclined plane 510. The engaging pin 540 is pushed into the third engaging hole 414 of the extended open housing 400 and the second engaging hole 332 of the connecting member 300. The stopper 355 is engaged with the notches 432. The connecting member 300 is locked against the extended open housing 400 in the folded condition.

As shown in FIG. 2, a rear wheel 130 and a fender 132 for braking the rear wheel are attached to the rear portion 120 of the footboard 100. The steering column 200 may be telescopic for reducing the height when folding. A front wheel 222 is attached to the lower end 220 of the steering column 200. A steering handle 242 is attached to the upper end 230 of the steering column 200. The steering handle 242 may be detached and mounted on a clip 245 attached to the steering column 200 in the folded condition.

The embodiments described in this specification and the contents disclosed therein are provided by way of illustration only. The invention can be applied equally well on other types of foldable scooter.

While the invention has been described in detail with reference to disclosed embodiments, various modifications within the scope of the invention will be apparent to those of ordinary skill in this technological field. It is to be appreciated that features described with respect to one embodiment typically may be applied to other embodiments.

What is claimed is:

1. A foldable scooter operating between an open condition and a folded condition, comprising:
a footboard comprising a front portion and a rear portion attached to a rear wheel;
a steering column comprising a lower end attached to a front wheel and an upper end attached to a steering handle;
a connecting member comprising a front portion rotatably connected to said steering column and a rear portion pivotally connected to the front portion of said footboard;
an engaging member for engaging the rear portion of said connecting member with the front portion of said footboard at the respective open and folded conditions;
a rotational driving member operating between a locked position and a released position for driving said engaging member between the open and folded conditions,
a first biasing device for disengaging said engaging member from said connecting member and footboard at the released position of said driving member, wherein said driving member is acted against said biasing device to engage said engaging member with said connecting member and footboard at the locked position,
whereby said driving member is turned between the locked and released positions to drive said engaging member between the open and folded conditions.

2. The foldable scooter as recited in claim 1, wherein said engaging member comprises at least one inclined plane disposed along a peripheral sector thereof with a first end and a second end, said driving member comprising at least one first portion to operate with said inclined plane,
whereby in the locked position, the first portion is rotated to said first end, in the released position, the first portion is rotated to said second end.

3. The foldable scooter as recited in claim 2, wherein said inclined plane is disposed on a plane of uniformed thickness, the perpendicular distance between the first end and said plane is greater than the perpendicular distance between the second end and said plane.

4. The foldable scooter as recited in claim 2, wherein said driving member further comprises a second portion, said engaging member further comprises a stopper for acting against said second portion, whereby the rotation of said driving member is confined.

5. The foldable scooter as recited in claim 2, wherein said driving member further comprise an indented third portion for receiving said first end in the locked position.

6. The foldable scooter as recited in claim 2, wherein said engaging member further comprises an engaging pin for engaging with a first and a second engaging hole disposed on said connecting member in the corresponding open and folded conditions.

7. The foldable scooter as recited in claim 1, further comprising:
a notch disposed at the front portion of said footboard, and
a stopper disposed at the rear portion of said connecting member for engaging said connecting member with said notch in the open condition.

8. The foldable scooter as recited in claim 7, wherein the front portion of said footboard further comprises an extended open housing aligned with and receiving said connecting member in the open condition, said housing comprising a base, said notch is formed at the base of said housing.

9. The foldable scooter as recited in claim 8, wherein said housing further comprises a pivot hole, said connecting member further comprises a pivot slot, wherein said housing and said connecting member are connected by a pivot pin disposed through said pivot hole, pivot slot, driving member and engaging member, said pivot pin is slidable along said pivot slot for said stopper to engage and disengage with said notch.

10. The foldable scooter as recited in claim 9, wherein a second biasing device is attached between said pivot pin and said stopper for biasing said stopper against said notch in the open condition.

11. The foldable scooter as recited in claim 8, wherein said connecting member is slidable along said housing when said stopper is engaged with or disengaged from said notch.

12. The foldable scooter as recited in claim 8, wherein said engaging member further comprises an engaging pin for engaging with a first and a second engaging hole disposed on said connecting member in the corresponding open and folded conditions, said housing further comprises a third engaging hole for engaging with said engaging pin in the open and folded conditions.

13. The foldable scooter as recited in claim 8, wherein said first biasing device is disposed between said engaging member and said housing.

14. The foldable scooter as recited in claim 10, wherein the rear portion of said connecting member further comprises a cover for shielding said second biasing device and pivot pin.

15. The foldable scooter as recited in claim 1, wherein said engaging member is shielded by said driving member.

16. The foldable scooter as recited in claim 2, wherein said driving member is round shaped.

17. The foldable scooter as recited in claim 1, wherein said first biasing device is a spring.

18. The foldable scooter as recited in claim 10, wherein said second biasing device is a spring.
